(19) United States
(12) Patent Application Publication
(10) Pub. No.: US 2024/0353607 A1
(43) Pub. Date: Oct. 24, 2024

(54) LIGHT GUIDE ELEMENT AND DISPLAY DEVICE

(71) Applicant: Coretronic Corporation, Hsin-Chu (TW)

(72) Inventors: Tzeng-Ke Shiau, Hsin-Chu (TW); Ying-Shun Syu, Hsin-Chu (TW)

(73) Assignee: Coretronic Corporation, Hsin-Chu (TW)

(21) Appl. No.: 18/623,022

(22) Filed: Mar. 31, 2024

(30) Foreign Application Priority Data
Apr. 21, 2023 (CN) 202310430802.5

(51) Int. Cl. F21V 8/00; G02F 1/1335

(52) U.S. Cl. CPC G02B 6/0036; G02B 6/0073; G02F 1/133607

(57) ABSTRACT

A light guide element, including a plurality of optical microstructures, has a structure disposed surface and an opposite surface opposite to each other. The plurality of optical microstructures are disposed on the structure disposed surface. Each optical microstructure includes a first surface and a second surface. A first end of the first surface is connected to the structure disposed surface, and a first end of the second surface is connected to a second end of the first surface. A second end of the second surface extends in a direction away from the structure disposed surface. A first included angle is sandwiched between the first surface and a reference plane parallel to the structure disposed surface, a second included angle is sandwiched between the second surface and the reference plane, and the first included angle is smaller than the second included angle.

### CROSS-REFERENCE TO RELATED APPLICATION

This application claims the priority benefit of China application serial no. 202310430802.5 filed on Apr. 21, 2023. The entirety of the above-mentioned patent application is hereby incorporated by reference herein and made a part of this specification.

### BACKGROUND

### Technical Field

The disclosure relates to an optical element and an electronic device, and in particular to a light guide element and a display device.

### Description of Related Art

Generally speaking, because the liquid crystal display includes a liquid crystal display panel. Since the liquid crystal display panel itself does not have the ability to emit light, the liquid crystal display panel need a surface light provided by the light emitting module, so that users may view images displayed on the liquid crystal display panel. At present, the light provided by the light emitting module passes will form scattered light through the microstructure of the light guide plate. However, only the light transmitted to the liquid crystal display panel is effective light, and the light without transmitted to the liquid crystal display panel will not have display information and is invalid light, and the invalid light will greatly reduce the contrast and luminance performance of the liquid crystal display. Therefore, how to reduce the invalid light is one of the important research and development topics in this field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a light guide element and a display device.

Other purposes and advantages of the disclosure may be further understood from the technical features disclosed in the disclosure.

In order to achieve one or part or all of the above objectives or other objectives, the disclosure provides a light guide element including a plurality of optical microstructures. The light guide element has a structure disposed surface and an opposite surface opposite to each other, the plurality of optical microstructures are disposed on the structure disposed surface, and the plurality of optical microstructures are recessed from the structure disposed surface toward the opposite surface. Each of the plurality of optical microstructures includes a first surface and a second surface. A first end of the first surface is connected to the structure disposed surface, and a first end of the second surface is connected to a second end of the first surface. A second end of the second surface extends in a direction away from the structure disposed surface. A first included angle is sandwiched between the first surface and a reference plane parallel to the structure disposed surface, a second included angle is sandwiched between the second surface and the reference plane, and the first included angle is smaller than the second included angle.

In order to achieve one or part or all of the above objectives or other objectives, the disclosure further provides a display device including a light emitting module and a display module. The light emitting module includes at least one light emitting unit and a light guide element. The at least one light emitting unit provides an illumination light beam. The light guide element is configured on a transmission path of the illumination light beam to guide the illumination light beam to transmit out of the light emitting module. The light guide element includes a plurality of optical microstructures. The light guide element has a structure disposed surface and an opposite surface opposite to each other, the plurality of optical microstructures are disposed on the structure disposed surface, and the plurality of optical microstructures are recessed from the structure disposed surface toward the opposite surface. Each of the plurality of optical microstructures includes a first surface and a second surface. A first end of the first surface is connected to the structure disposed surface, and a first end of the second surface is connected to a second end of the first surface. A second end of the second surface extends in a direction away from the structure disposed surface. A first included angle is sandwiched between the first surface and a reference plane parallel to the structure disposed surface, a second included angle is sandwiched between the second surface and the reference plane, and the first included angle is smaller than the second included angle. The display module is configured on the transmission path of the illumination light beam from the light guide element to convert the illumination light beam into an image light beam and transmit out of the display device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display device according to an embodiment of the disclosure.

FIG. 2 is a schematic diagram of a display device according to another embodiment of the disclosure.

FIG. 3 is a schematic diagram of an optical microstructure of a light guide element according to an embodiment of the disclosure.

FIG. 4 is a schematic diagram of an optical microstructure of a light guide element according to another embodiment of the disclosure.

FIG. 5 is a schematic diagram of an optical microstructure of a light guide element according to another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

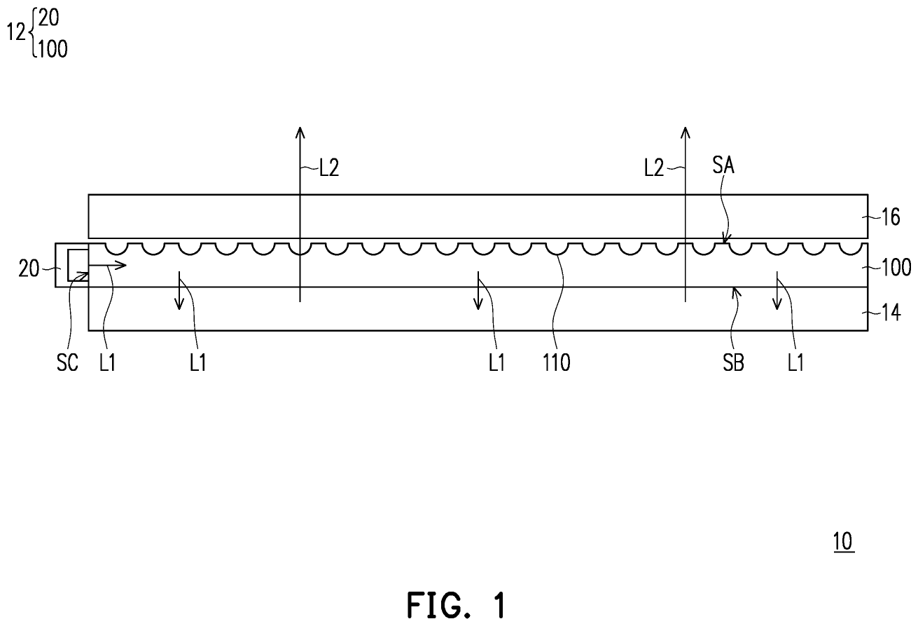

FIG. 1 is a schematic diagram of a display device according to an embodiment of the disclosure. Please refer to FIG. 1. The embodiment provides a display device 10 to provide an image light beam L2. The display device 10 includes a light emitting module 12 and a display module 14. The light emitting module 12 includes at least one light emitting unit 20 and a light guide element 100. The light emitting unit 20 is, for example, a light emitting diode strip. The light emitting unit 20 is configured on a side of a surface of the light guide element 100 to provide an illumination light beam L1. In different embodiments, two light emitting units 20 may be configured on two opposite surfaces (for example, the left side and the right side of FIG. 1) of the light guide element 100, but the disclosure is not limited thereto. The light guide element 100 is configured on a transmission path of the illumination light beam L1 to guide the illumination light beam L1 to transmit out of the light emitting module 12. The light guide element 100 has a structure disposed surface SA, an opposite surface SB and a plurality of optical microstructures 110, the structure disposed surface SA and the opposite surface SB are the two opposite surfaces of the light guide element 100 (for example, the upper side and the lower side of FIG. 1), and the plurality of optical microstructures 110 are disposed on the structure disposed surface SA. The light guide element 100 will be described in the following paragraphs.

The display module 14 is configured on the transmission path of the illumination light beam L1 from the light guide element 100 to convert the illumination light beam L1 into the image light beam L2. The display module 14 may be a liquid crystal display (LCD) panel, an electrowetting display panel, an electrophoretic display panel, or other types of display panels (for example, non-self-illuminating display panels). For example, in this embodiment, the light emitting module 12 is disposed on the display module 14, in which the display module 14 is a reflective liquid crystal display panel (RLCD panel), but the disclosure is not limited thereto. Specifically, in this embodiment, the light emitting module 12 is disposed on a light (image light beam L2) exiting surface of the display module 14 (for example, the surface of the display module 14A facing the light guide element 100), and the structure disposed surface SA is a surface of a side of the light guide element 100 away from the display module 14. Therefore, in this embodiment, due to the arrangement of the plurality of optical microstructures 110, the illumination light beam L1 transmitted in the light guide element 100 can enters the display module 14 through the light exiting surface of the display module 14. The display module 14 converts the illumination light beam L1 into the image light beam L2. The image light beam L2 is emitted from the light exiting surface of the display module 14 and passes through the light emitting module 12 and then transmitted out of the display device 10.

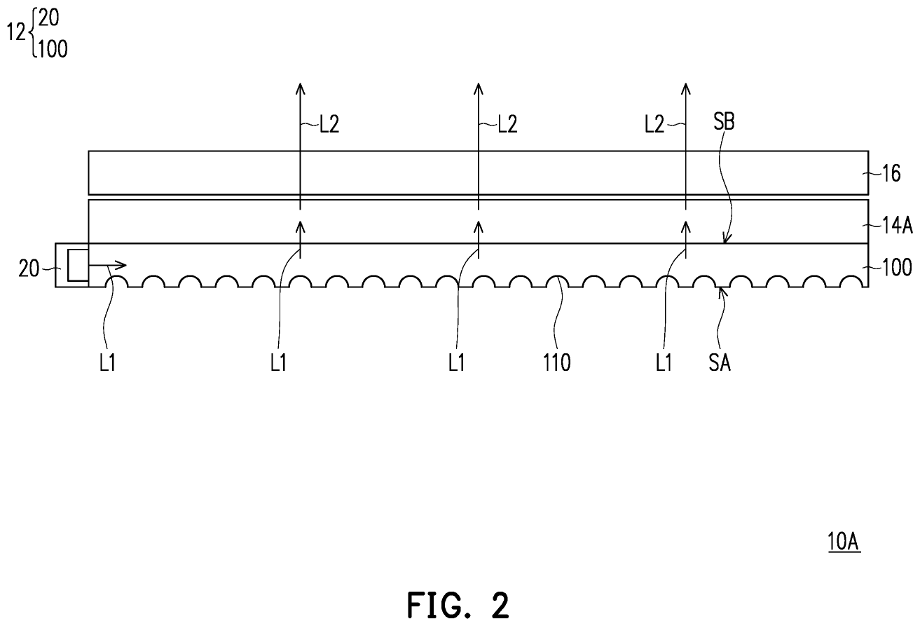

FIG. 2 is a schematic diagram of a display device according to another embodiment of the disclosure. In the embodiment of FIG. 2, a display module 14A of a display device 10A is a transmissive liquid crystal display panel. In this embodiment, the light emitting module 12 is disposed under the display module 14A, and the structure disposed surface SA is a surface of a side of the light guide element 100 away from the display module 14. Therefore, in the embodiment in FIG. 2, due to the arrangement of the plurality of optical microstructures 110, the illumination light beam L1 transmitted in the light guide element 100 can enters the display module 14 through a light (illumination light beam L1) incident surface of the display module 14A (for example, the surface of the display module 14A facing the light guide element 100). The display module 14 converts the illumination light beam L1 into the image light beam L2, and the image light beam L2 is transmitted from the light exiting surface of the display module 14A in a direction away from the light emitting module 12 and then transmitted out of the display device 10A. It should be further noted that, in the embodiment shown in FIG. 1 and FIG. 2, the structure disposed surface SA and the opposite surface SB may be replaced with each other. For example, the structure disposed surface SA (the surface on which the optical microstructure 110 is configured) may also be a surface of the light guide element 100 facing the display modules 14 and 14A, in other words, the optical microstructure 110 may be disposed on a surface of the light guide element 100 facing the display modules 14 and 14A.

In the embodiment of FIG. 1 and FIG. 2, the display device 10, 10A may further include a touch element 16, and the touch element 16 is disposed on a transmission path of the image light beam L2. In the embodiment of FIG. 1, the light guide element 100 is disposed between the touch element 16 and the display module 14. In the embodiment of FIG. 2, the display module 14A is disposed between the touch element 16 and the light guide element 100.

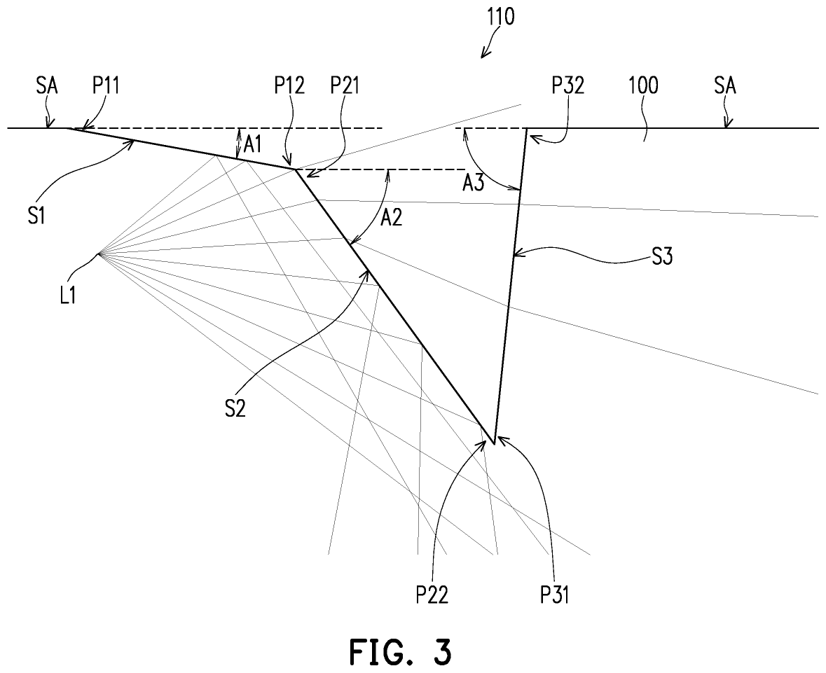

FIG. 3 is a schematic diagram of an optical microstructure of a light guide element according to an embodiment of the disclosure. The optical microstructure 110 shown in this embodiment can at least be applied to the light guide element 100 of FIG. 1 or FIG. 2, and the following description will be applied to the light guide element 100 of FIG. 1 as an example. Please refer to FIG. 1 and FIG. 3. The light guide element 100 further has a light incident surface SC connecting the structure disposed surface SA and the opposite surface SB. The illumination light beam L1 emitted by the light emitting unit 20 enters the light guide element 100 from the light incident surface SC. The plurality of optical microstructures 110 are disposed on the structure disposed surface SA, and the plurality of optical microstructures 110 are recessed from the structure disposed surface SA toward the opposite surface SB. In different embodiments, the plurality of optical microstructures 110 may be distributed on the structure disposed surface SA in a random manner. For example, a distribution density of the plurality of optical microstructures 110 adjacent to the light incident surface SC of the light guide element 100 is less than a distribution density of the plurality of optical microstructures 110 away from the light incident surface SC of the light guide element 100, which has a good optical effect, but the disclosure is not limited thereto.

In this embodiment, each optical microstructure 110 includes a first surface S1 and a second surface S2, in which a shape of the first surface S1 on the cross-section plane perpendicular to the light incident surface SC and the structure disposed surface SA (the cross-section plane is, for example, the plane in FIG. 3, a symmetry plane of the optical microstructure 110) is a straight line segment having a first end P11 and a second end P12 opposite to each other, and a shape of a second surface S2 on the cross-section plane perpendicular to the light incident surface SC and the structure disposed surface SA is a straight line segment also having a first end P21 and a second end P22 opposite to each other. It should be noted that surfaces (such as the first surface S1 and the second surface S2) included in each optical microstructure 110 are not necessarily planar, and may also be designed as non-planar as required, such as curved, spherical, or irregular surfaces (that is, the outer contour of the projection area of each optical microstructure 110 on the structure disposed surface SA is, for example, circle, semicircle, oval, spindle-shaped, or crescent-shaped), and the disclosure is not limited thereto. The first end P11 of the first surface S1 is connected to the structure disposed surface SA, the first end P21 of the second surface S2 is connected to the second end P12 of the first surface S1, and the second end P22 of the second surface S2 extends in a direction away from the structure disposed surface SA. In addition, a first included angle A1 is sandwiched between the first surface S1 and a reference plane parallel to the structure disposed surface SA, a second included angle A2 is sandwiched between the second surface S2 and the reference plane parallel to the structure disposed surface SA, the first included angle A1 is smaller than the second included angle A2, the first included angle A1 and the second included angle A2 are acute angles respectively, and the reference plane is illustrated with a dotted line. It should also be noted that the intersection of each surface in each optical microstructure 110 may be designed to have a chamfered or rounded structure, so the angle of the included angles may be defined as included angle formed by the intersection of the extensions of each surface, but the disclosure is not limited thereto. Therefore, when the illumination light beam L1 is transmitted from the light emitting unit 20 to the light guide element 100, through the design of the illumination light beam L1 of the first surface S1 and the second surface S2 in the optical microstructure 110, it can greatly reduce the ineffective light beam that the illumination beam L1 directly emits from the light guide element 100 (without reflected by the display module 14), and the optical effect can be further improved. For example, when the first included angle A1 is less than or equal to 25 degrees, and the absolute value of the difference between the first included angle A1 and the second included angle A2 is greater than or equal to 10 degrees, the effect is good.

Specifically, in this embodiment, the optical microstructure 110 further includes a third surface S3, a shape of the third surface S3 on the cross-section plane perpendicular to the light incident surface SC and the structure disposed surface SA is a straight line segment having a first end P31 and a second end P32 opposite to each other. The first end P31 of the third surface S3 is connected to the second end P22 of the second surface S2, the second end P32 of the third surface S3 extends in a direction away from the opposite surface SB, and the second end P32 of the third surface S3 is connected to the structure disposed surface SA. The first surface S1 and the second surface S2 of the optical microstructure 110 are located between the light incident surface SC and the third surface S3. In other words, in this embodiment, the first surface S1 and the second surface S2 are formed as a light receiving surface of the optical microstructure 110, and the third surface S3 is formed as a backlight surface of the optical microstructure 110. In addition, in this embodiment, a third included angle A3 is sandwiched between the third surface S3 and the reference plane, and the third included angle A3 is greater than or equal to 60 degrees.

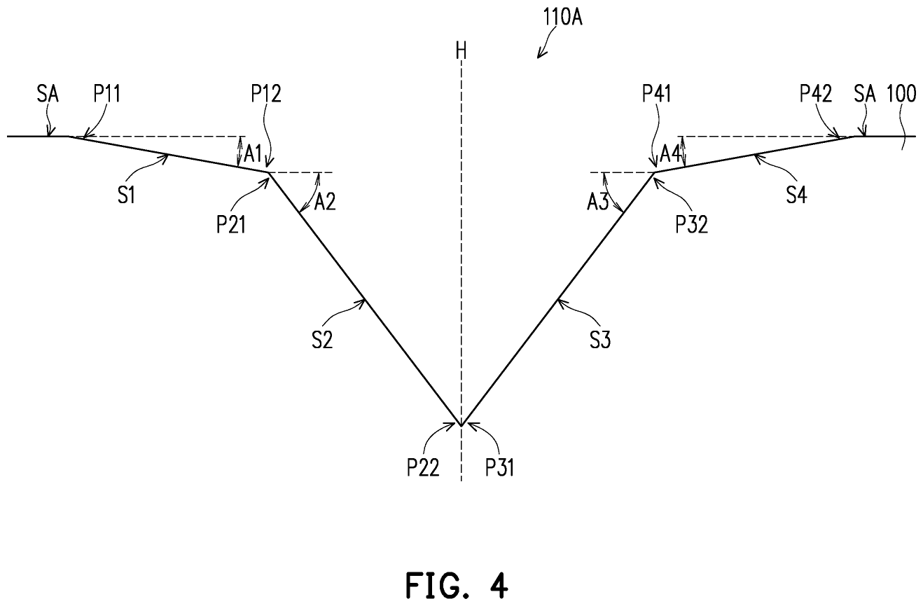

FIG. 4 is a schematic diagram of an optical microstructure of a light guide element according to another embodiment of the disclosure. Please refer to FIG. 1 and FIG. 4. The light guide element 100 shown in FIG. 1 or FIG. 2 may use an optical microstructure 110A of this embodiment, and the following description will be the light guide element 100 shown in FIG. 1 as an example. In addition, the optical microstructure 110A shown in this embodiment is similar to the optical microstructure 110 shown in FIG. 3. The difference between the two is that, in this embodiment, the second end P32 of the third surface S3 is not connected to the structure disposed surface SA, and each optical microstructure 110A also includes a fourth surface S4, and a shape of the fourth surface S4 on the cross-section plane perpendicular to the light incident surface SC and the structure disposed surface SA is a straight line segment, in which two ends of the fourth surface S4 (namely a first end P41 and a second end P42 shown in FIG. 4) are respectively connected to the second end P32 of the third surface S3 and the structure disposed surface SA, each optical microstructure 110A includes a line of symmetry H, the line of symmetry H is perpendicular to the structure disposed surface SA. Taking the line of symmetry H as the symmetry axis, the line segment of the first surface S1 is symmetrical to the line segment of the fourth surface S4, and the line segment of the second surface S2 is symmetrical to the line segment of the third surface S3. That is, in this embodiment, the third included angle A3 is equal to the second included angle A2, and a fourth included angle A4 sandwiched between the fourth surface S4 and the reference plane is equal to the first included angle A1. In other words, the embodiment provides the optical microstructure 110A with left-right (mirror) symmetry centered on the line of symmetry H, which may be further applied to the light guide element 100 where light enters from two opposite sides. In this way, when the illumination light beam L1 is transmitted from the light emitting unit 20 to the light guide element 100, through the design from the first surface S1 to the fourth surface S4 in the optical microstructure 110, the illumination light beam L1 can greatly reduce ineffective light beams emitted directly from the light guide element 100, and the optical effect can be further improved.

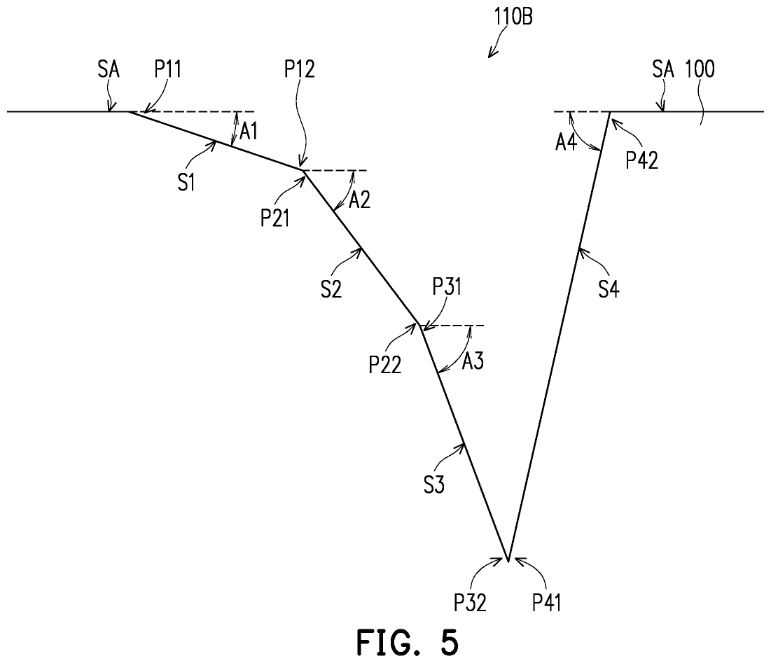

FIG. 5 is a schematic diagram of an optical microstructure of a light guide element according to another embodiment of the disclosure. Please refer to FIG. 1 and FIG. 5. The light guide element 100 shown in FIG. 1 or FIG. 2 may use an optical microstructure 110B of this embodiment, and the following description will be applied to the light guide element 100 shown in FIG. 1 as an example. In addition, the optical microstructure 110B shown in this embodiment is similar to the optical microstructure 110A shown in FIG. 4. The difference between the two is that, in this embodiment, the second end P32 of the third surface S3 extends in a direction away from the structure disposed surface SA, and the third included angle A3 is greater than the second included angle A2. In addition, the fourth included angle A4 is sandwiched between the fourth surface S4 and the reference plane, and the fourth included angle A4 is greater than or equal to 60 degrees. In this embodiment, the first surface S1, the second surface S2, and the third surface S3 are located between the light incident surface SC and the fourth surface S4. In other words, in this embodiment, the first surface S1, the second surface S2, and the third surface S3 are formed as the light receiving surface in the optical microstructure 110B, and the fourth surface S4 is formed as the backlight surface in the optical microstructure 110B. In this way, when the illumination light beam L1 is transmitted from the light emitting unit 20 to the light guide element 100, through the design of the illumination light beam L1 from the first surface S1 to the fourth surface S4 in the optical microstructure 110B, ineffective light beams emitted directly from the light guide element 100 can be greatly reduced, and the optical effect can be further improved.

In summary, in the light guide element and display device of the disclosure, each optical microstructure includes the first surface and the second surface. The first included angle is sandwiched between the first surface and the reference plane parallel to the structure disposed surface of the light guide element, the second included angle is sandwiched between the second surface and the reference plane, and the first included angle is smaller than the second included angle. Therefore, when the illumination light beam is provided to the light guide element, through the design of the illumination light beam of the first surface and the second surface in the optical microstructure, ineffective light beams emitted directly from the light guide element can be greatly reduced, thereby improving the optical effect.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light guide element comprising a plurality of optical microstructures, wherein:
the light guide element has a structure disposed surface and an opposite surface opposite to each other, the plurality of optical microstructures are disposed on the structure disposed surface, the plurality of optical microstructures are recessed from the structure disposed surface toward the opposite surface, and each of the plurality of optical microstructures comprises a first surface and a second surface, wherein:
a first end of the first surface is connected to the structure disposed surface;
a first end of the second surface is connected to a second end of the first surface, and a second end of the second surface extends in a direction away from the structure disposed surface; and
a first included angle is sandwiched between the first surface and a reference plane parallel to the structure disposed surface, a second included angle is sandwiched between the second surface and the reference plane, and the first included angle is smaller than the second included angle.

2. The light guide element according to claim 1, wherein the first included angle is less than or equal to 25 degrees.

3. The light guide element according to claim 1, wherein an absolute value of a difference between the first included angle and the second included angle is greater than or equal to 10 degrees.

4. The light guide element according to claim 1, wherein each of the plurality of optical microstructures further comprises a third surface, a first end of the third surface is connected to a second end of the second surface, a second end of the third surface extends in a direction away from the opposite surface, and a second end of the third surface is connected to the structure disposed surface.

5. The light guide element according to claim 4, wherein a third included angle is sandwiched between the third surface and the reference plane, and the third included angle is greater than or equal to 60 degrees.

6. The light guide element according to claim 4, wherein the light guide element further has a light incident surface connecting the structure disposed surface and the opposite surface, and the first surface and the second surface are located between the light incident surface and the third surface.

7. The light guide element according to claim 1, wherein each of the plurality of optical microstructures further comprises a third surface and a fourth surface, a first end of the third surface is connected to the second end of the second surface, and two ends of the fourth surface are respectively connected to a second end of the third surface and the structure disposed surface.

8. The light guide element according to claim 7, wherein the second end of the third surface extends in a direction away from the opposite surface, and each of the plurality of optical microstructures comprises a line of symmetry, the first surface is symmetrical to the fourth surface, and the second surface is symmetrical to the third surface.

9. The light guide element according to claim 7, wherein the second end of the third surface extends in a direction away from the structure disposed surface, a third included angle is sandwiched between the third surface and the reference plane, and the third included angle is greater than the second included angle.

10. The light guide element according to claim 9, wherein a fourth included angle is sandwiched between the fourth surface and the reference plane, and the fourth included angle is greater than or equal to 60 degrees.

11. The light guide element according to claim 7, wherein the light guide element further has a light incident surface connecting the structure disposed surface and the opposite surface, the first surface, the second surface, and the third surface are located between the light incident surface and the fourth surface.

12. A display device comprising a light emitting module and a display module, wherein:
the light emitting module comprises at least one light emitting unit and a light guide element, wherein:
the at least one light emitting unit provides an illumination light beam; and
the light guide element is configured on a transmission path of the illumination light beam to guide the illumination light beam to transmit out of the light emitting module, and the light guide element comprises a plurality of optical microstructures, wherein:
the light guide element has a structure disposed surface and an opposite surface opposite to each other, the plurality of optical microstructures are disposed on the structure disposed surface, the plurality of optical microstructures are recessed from the structure disposed surface toward the opposite surface, and each of the plurality of optical microstructures comprises a first surface and a second surface, wherein:
a first end of the first surface is connected to the structure disposed surface;
a first end of the second surface is connected to a second end of the first surface, and a second end of the second surface extends in a direction away from the structure disposed surface; and
a first included angle is sandwiched between the first surface and a reference plane parallel to the structure disposed surface, a second included angle is sandwiched between the second surface and the reference plane, and the first included angle is smaller than the second included angle; and
the display module is configured on the transmission path of the illumination light beam from the light guide element to convert the illumination light beam into an image light beam and transmit out of the display device.

13. The display device according to claim 12, wherein the image light beam is emitted from the display module and pass through the light emitting module and then transmitted out of the display device.

14. The display device according to claim 12, wherein the display module is a transmissive liquid crystal display panel, and the image light beam is transmitted from the display module in a direction away from the light emitting module and then out of the display device.
